(19) United States
(12) Patent Application Publication
(10) Pub. No.: US 2025/0242504 A1
(43) Pub. Date: Jul. 31, 2025

(54) Parallel Kinematic Manipulator

(71) Applicant: James Alan Kennon, Benicia, CA (US)

(72) Inventor: James Alan Kennon, Benicia, CA (US)

(21) Appl. No.: 19/016,886

(22) Filed: Jan. 10, 2025

Related U.S. Application Data
(60) Provisional application No. 63/630,406, filed on Jan. 31, 2024.

(51) Int. Cl. B25J 17/02; B25J 9/00

(52) U.S. Cl. CPC B25J 17/0266; B25J 9/0045

(57) ABSTRACT

A method and an apparatus for providing six degrees of precision motion. As disclosed herein a parallel kinematic manipulator is formed using six fixed length kinematic supporting links. The kinematic links may include a high-resolution position encoder to provide position feedback information. Movement of the manipulator is affected using six linear thrust mechanisms along two parallel linear slide mechanisms. The combination of a parallel kinematic structure and six linear actuators on two linear slides provides a manipulator capable of six degrees of freedom to position components or instruments with high accuracy, stiffness, and/or repeatability with an exceptionally long travel in one degree of freedom.

### PRIORITY

This application claims the benefit of co-pending provisional application 63/630,406 by the same inventor, filed Jan. 31, 2024 which is included by reference as if fully set forth herein.

### BACKGROUND

Many mechanisms utilizing parallel kinematics such as Stewart Platforms and Hexapods exist today. To achieve six degrees of freedom (6DoF) most of the parallel kinematic mechanisms require six independent motion control actuators. Typically. these 6DoF mechanisms have limited motion in all six degrees of freedom. There is a cost associated with six completely independent motion systems, so a system with superior functionality for less cost is needed by the industry.

### SUMMARY

The present disclosure shows a novel integration of several motion control components to achieve six degree of freedom (6DoF) motion with two primary motion axes. This results in reduced cost and system complexity compared to other 6DoF parallel kinematic mechanisms. The two primary motion axes can be extended to enable one of the six axes to have extremely long travel.

### BRIEF DESCRIPTION OF DRAWINGS

FIG. 1 depicts a side view of the short travel axis of the device according to various embodiments of the present invention and includes details of thrust and position feedback elements.

FIG. 2 depicts an isometric view of the device according to various embodiments of the present invention.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The terminology used herein is for the purpose of describing particular embodiments only and is not intended to be limiting of the invention.

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example, and without limitation, in cases in which a measure or value is “relatively increased” or “relatively more”, that comparison need not be with respect to any known measure or value, but might be with respect to a measure or value held by that measurement or value at another place or time.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The term “substantial effect” (and similar terms and phrases) generally indicates any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

As used herein, the term “and/or” includes all combinations of one or more of the associated listed items. As used herein. the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements. and/or components, but do not preclude the presence or addition of one or more other features, steps, operations, elements, components, and/or groups thereof.

### DETAILED DESCRIPTION

The present disclosure is to be considered as an exemplification of the invention and is not intended to limit the invention of the specific embodiments illustrated by the figures or description below. The present invention will now be described by referencing the appended figures representing illustrative embodiments.

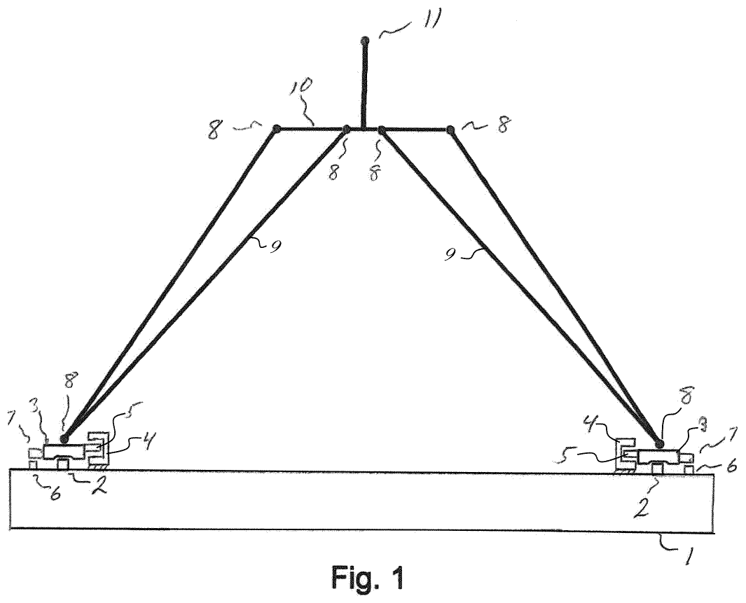

FIG. 1 depicts a view across the short traveler looking down the long travel axis. This embodiment shows an exemplary base platform 1. Two linear motion guides 2 provide support for the linear guide carriages 3 and constrain the carriages in all but one degree of motion—the long travel direction. In the embodiment of FIG. 1 the linear motion guides 2 and linear guide carriages 3 may be air bearings or recirculating ball guide rails, although other mechanisms may provide this or similar functionality. Each guide carriage 3 has a thrust driver 5 attached to provide for positioning of the guide carriage 3 along the linear motion guide 2. The guide carriage 3 thrust is reacted against the thrust reference 4 to provide the guide carriage 3 motion. Collectively the thrust driver 5 and thrust reference 4 may operate as a linear motor. A linear motor may be an electric motor that has had its stator and rotor “unrolled”, thus, instead of producing a torque (rotation), it produces a linear force along its length. In an embodiment employing a linear motor, thrust reference 4 may be composed of magnetic material and thrust driver 5 may be electrically conductive coils.

In the embodiment of FIG. 1 the thrust mechanisms may be linear motors, a screw and rotating nut, a rack and pinion, or other linear motion mechanism that provides this or a similar functionality.

The position of the guide carriages 3 is provided by position references 6 and a position detector 7 attached to each of the guide carriages 3. In some embodiments the position reference 6 and position detectors 7 are absolute position sensing optical scales and read heads, although many other linear position sensing technologies may provide this or similar function.

Each guide carriage 3 has a multi-axis pivot 8 attached to position an end of a fixed length support bar 9. The opposite end of each support bar 9 is coupled to another multi-axis pivot 8 that is attached to a motion platform 10. The desired position of the motion platform 10 is derived geometrically from the desired position of the working point 11 in all six degrees of freedom (6DoF). To effectuate the desired movement and position of the working point 11, a control system (not shown) may calculate the position of the motion platform's 10 supporting multi-axis pivot 8 locations in three-dimensional (3D) space, based on the user's requested 6DoF position (X, Y, Z, rotation about X, rotation about Y, and rotation about Z) as described in more detail herein. Once the desired position of the motion platform's 10 multi-axis pivot 8 locations are known, the motion control system may calculate the required position of the guide carriages 3, based on the fixed support bar 9 length and the relationship with the fixed position of the linear motion guides 2. This calculation may be effectuated with two Pythagorean calculations per guide carriage 3.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effectuate such feature, structure or characteristic in connection with other embodiments whether or not explicitly described. Parts of the description are presented using terminology commonly employed by those of ordinary skill in the art to convey the substance of their work to others of ordinary skill in the art.

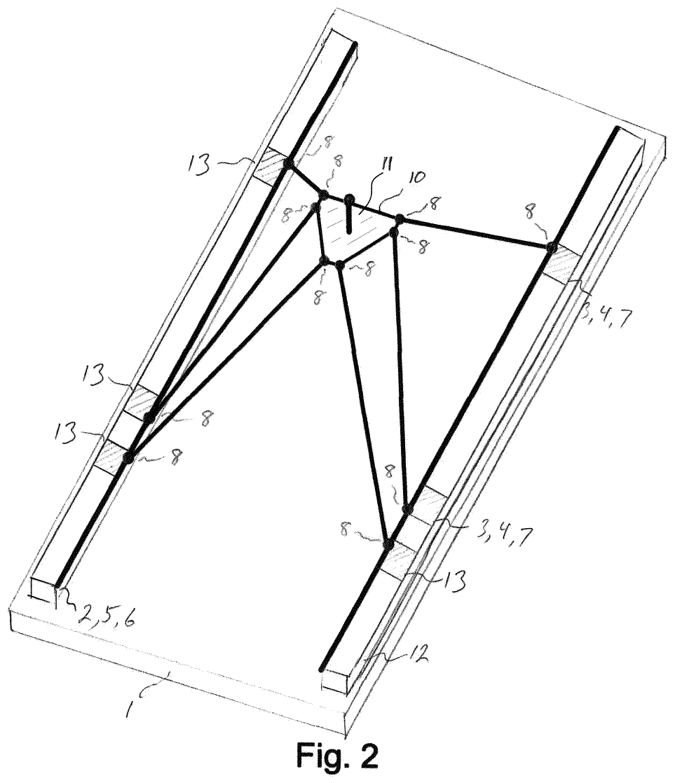

FIG. 2 depicts an isometric view of an embodiment to give an overall perspective of the geometric relationships of the motion platform 10, and to show the six upper most multi-axis pivots 8, the six fixed length support bars 9, the lower six multi-axis pivots 8, and the moving motion control elements 13. The motion control elements 13 include guide carriage 3, thrust reference 4, and position detector 7. FIG. 2 also depicts the arrangement of the base platform 1 to the fixed motion control elements 12. The fixed motion control elements 12 include linear motion guides 2, thrust driver 5, and position reference 6.

In operation as the moving motion control elements 13 traverse the Fixed motion control elements 12 they push and pull on the support bars 9 thereby moving the motion platform 10 and working point 11 to the desired position.

Although it is not required for the multi-axis pivots 8 to have their degrees of freedom be coincident, a motion algorithm with the pivot axes coincident may be effectuated by way of example. For any given working point 11 location the motion platform's 10 six pivot locations 8 may be calculated using trigonometric functions based on the fixed relationship of the platform's pivot points to the desired working point 11. With the known motion platform's 10 multi-axis pivot 8 positions in cartesian space, the fixed length of the support bars 9, and the fixed position of the two linear motion guides 2 the position of the moving motion control elements 13 may be calculated using Pythagorean algorithms. The first step is to calculate the vector of the motion platform's 10 multi-axis pivots 8, to the moving motion control elements 13, in the direction perpendicular to the moving motion control elements 13. The hypotenuse of this calculation is now used with the fixed support bars 9 lengths (as the hypotenuse) to calculate the longitudinal position of the moving motion control elements 13 using a second Pythagorean calculation. Once known, the motion control elements 13 may be placed in position.

On having skill in the art will appreciate that the lengths of the fixed-length support bars 9 and the width of the base platform 1 may be altered to fit a desired application. For example, and without limitation, increasing the distance between the linear motion guides 2 will allow for the working point 11 to be disposed lower and closer to the base platform.

Other embodiments may include a triangular motion platform with a first bar (or elongated member) pivotably coupled to a first position on the platform. The first bar may be pivotably coupled to a first moveable carriage at the far end. The carriage may slide on a motion guide. A second bar may be coupled to a second position on the motion platform at a proximate end and pivotably coupled to a second moveable carriage at a far end which is mounted on a second motion guide. This structure may be repeated so there are multiple support bars (six are shown) each coupled to a slidable carriage. Some of the carriages may be on the first linear motion guide and others on the second linear motion guide.

Once disposed this way, moving the carriages will affect the disposition of the motion platform. For example, and without limitation, if all the support bars are moved as close together as possible, the platform will be projected up to its highest position. Similarly, if the bars are far apart, the platform will be lower. Platform angle and rotation may be affected in a similar manner-by moving the support bars. The shape of the platform may also be varied to effect certain requirements. For example, and without limitation, a triangularly shaped motion platform may provide for better rotational operation.

In addition to moving the platform to known positions, control of the support bars through the motion of carriages may also provide for pre-programmed paths (or traces) for movement of a platform. For example, and without limitation, if a user desired to cut away material or provide for 3D printing of a work, then the motion of the carriages may be calculated to provide for the proper path to effectuate the desired cut or deposition of material. This may entail operating all six carriages at the same time if a complicated shape is desired.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed:

1. A device including:
A platform;
a first elongated member pivotably coupled to a first position on the platform at a proximate end and pivotably coupled to a first moveable carriage at a distal end, said first moveable carriage slidably coupled to a first motion guide;
a second elongated member pivotably coupled to a second position on the platform at a proximate end and pivotably coupled to a second moveable carriage at a distal end, said second moveable carriage slidably coupled to the first motion guide;
a third elongated member pivotably coupled to a third position on the platform at a proximate end and pivotably coupled to a third moveable carriage at a distal end, said third moveable carriage slidably coupled to the first motion guide;
a fourth elongated member pivotably coupled to a fourth position on the platform at a proximate end and pivotably coupled to a fourth moveable carriage at a distal end, said fourth moveable carriage slidably coupled to a second motion guide;
a fifth elongated member pivotably coupled to a fifth position on the platform at a proximate end and pivotably coupled to a fifth moveable carriage at a distal end, said fifth moveable carriage slidably coupled to the second motion guide, and
a sixth elongated member pivotably coupled to a sixth position on the platform at a proximate end and pivotably coupled to a sixth moveable carriage at a distal end, said sixth moveable carriage slidably coupled to the second motion guide.

2. The device of claim 1 wherein the first and the second motion guides are disposed substantially parallel to each other.

3. The device of claim 1 wherein the first moveable carriage includes a thrust driver.

4. The device of claim 3 wherein the thrust driver is electrically driven and the first motion guide includes a magnetic thrust reference.

5. The device of claim 1 wherein the first motion guide includes a position sensor for sensing the position of the first moveable carriage.

6. The device of claim 1 wherein the platform is substantially triangular and the elongated members are coupled to the platform at substantially at the vertexes.

7. A positioning device including:
a first guide carriage, said first guide carriage including a thrust reference, said first guide carriage disposed to interact with a first linear motion guide, said first linear motion guide restricting motion of the first guide carriage to a single axis;
a first multi-axis pivot disposed on said first guide carriage, said first multi-axes pivot coupled to a proximate end of a first support bar;
a second multi-axis pivot coupled to a distal end of the first support bar, said second multi-axis pivot disposed on a motion platform;
a second guide carriage, said second guide carriage disposed to interact with a second linear motion guide, said second linear motion guide restricting motion of the second guide carriage to a single axis;
a third multi-axis pivot disposed on said second guide carriage, said third multi-axes pivot coupled to a proximate end of a second support bar, and
a fourth multi-axis pivot coupled to a distal end of the second support bar, said second multi-axis pivot disposed on the motion platform.

8. The device of claim 7 wherein the first and the second linear motion guides are disposed substantially parallel to each other.

9. The device of claim 7 wherein the first moveable carriage includes a thrust driver.

10. The device of claim 9 wherein the thrust driver is electrically driven.

11. The device of claim 7 wherein the first linear motion guide includes a position sensor for sensing the position of the first guide carriage.

12. The device of claim 7 wherein the motion platform is substantially triangular and the multi-axes pivots are coupled to the platform at substantially at the vertexes.
